(19) United States
(12) Patent Application Publication
(10) Pub. No.: US 2014/0222568 A1
(43) Pub. Date: Aug. 7, 2014

(54) TARGETED ADVERTISEMENT DISTRIBUTION TO MOBILE DEVICES

(71) Applicant: mADtivity, Inc., San Jose, CA (US)

(72) Inventor: Stan David Weitzman, San Jose, CA (US)

(73) Assignee: mADtivity, Inc., San Jose, CA (US)

(21) Appl. No.: 14/244,877

(22) Filed: Apr. 3, 2014

Related U.S. Application Data
(60) Provisional application No. 61/808,498, filed on Apr. 4, 2013.

(51) Int. Cl. G06Q 30/02

(52) U.S. Cl. CPC G06Q 30/0261; G06Q 30/0269; G06Q 30/0259
USPC 705/14.57; 705/14.58

(57) ABSTRACT

A method and system are provided for presenting highly targeted advertisements to the user of a mobile device running an application which incorporates a Mobile Agent designed according to the disclosure. The Mobile Agent communicates with an advertising server that analyzes information received from the Mobile Agent, and selects advertisements for transmission to the Mobile Agent and presentation to the user. The disclosure uses the intended audiences of the available advertisements, the nature of the application, and the user's history of responses to previous advertisements to select advertisements that are likely to be considered useful by the user. The disclosure further uses information about the mobile device's position and its direction and speed of motion, and the locations of places of business associated with the available advertisements, to select advertisements for places of business that are proximate to the user's position, predicted destination, or predicted route.

### CROSS-REFERENCE TO RELATED APPLICATIONS

This patent application claims the priority benefit of U.S. provisional patent application No. 61/808,498, filed Apr. 4, 2013, the disclosure of which is incorporated by reference.

### TECHNICAL FIELD

The present disclosure relates generally to presentation of mobile advertising to information appliances, and more specifically to selection and presentation of mobile advertising that is relevant for an individual user.

### BACKGROUND

Typical mobile advertising platforms have several limitations. They select advertisements based on criteria that have little to do with the target user's interests or immediate situation. In particular, they do not take account of the user's current activity, and if the user is traveling, the user's mode of travel, location, and destination. This reduces the effectiveness of advertising from the advertiser's point of view by presenting advertisements to many users who are not interested in them or are not in a position to act on them. At the same time it reduces the effectiveness of the advertising platform and the reputation of the advertiser by presenting many advertisements to the user which are not of interest or which the user is not in a position to act on.

The present disclosure addresses these limitations by presenting targeted advertising based on highly accurate positioning information using a mathematical algorithm combining Kalman filter technology and

Quaternion mathematics. The present disclosure also selects advertisements based on the user's interests, using a Bayesian stochastic algorithm.

### SUMMARY

This summary introduces the present disclosure in a simplified form that is further described in the Detailed Description below. This summary is not intended to identify key features or essential features of the claimed subject matter, nor is it intended to be used as an aid in determining the scope of the claimed subject matter.

Services that present advertisements to users of mobile devices are widely used. It is highly desirable for such a service to present advertisements that are precisely targeted to each user. Advertisements that are not so targeted waste much of the advertisers' resources, and by irritating users, they negatively affect the users' attitudes about advertisers whom they might otherwise view favorably. Thus there is a need for advertising services that present to each user only advertisements that the user is likely to consider useful.

The present disclosure presents advertisements to a mobile device user which are targeted in several novel ways. The disclosure classifies each advertisement according to the market it is directed at, and classifies each user according to the purpose of the application (“the app”) the user is running, the user's history of responses to previous advertisements, and other factors. The disclosure then filters the advertisements so that only those advertisements which the user is likely to consider useful are presented to the user.

The present disclosure further tracks the mobile device's location and its velocity (its speed and direction of motion) and deduces additional information from those data, including the user's mode of travel and the user's predicted route and destination. The disclosure uses this information to further filter the available advertisements and present only those associated with places of business that are proximate to the user's position, predicted route, or predicted destination.

The disclosure comprises a Mobile Agent that is integrated into an app by the app's developer. The disclosure becomes active when the user opens an app that contains the integrated Mobile Agent. The Mobile Agent collects raw data about the mobile device's location and motion, about the user's responses to advertisements, and about the user's other activities, and transmits the raw data to an advertisement server (“the Adserver”). The Adserver records and analyzes the raw data, uses it to select advertisements, and transmits the advertisements to the Mobile Agent for presentation to the user.

The present disclosure may further provide means within an advertisement to connect the user with the advertiser's reservation system.

### BRIEF DESCRIPTION OF THE DRAWINGS

Embodiments are illustrated by way of example, and not by limitation, in the figures of the accompanying drawings, in which like references indicate similar elements and in which:

FIG. 1 shows the relationship between the mobile device and the Adserver.

FIG. 2 shows an embodiment of the present disclosure which is a process that determines the position of a mobile device, selects one or more advertisements to present to a user of the device, and transmits the advertisements to the device, where they are presented to the user.

FIG. 3 shows the important databases in the Adserver in the embodiment of the disclosure shown in FIG. 2 and the flow of data among them.

FIG. 4 shows part of a system for presenting advertisements to a mobile device user according to one embodiment of the present disclosure. This figure shows components that are associated with the mobile device and with an Adserver's interactions with the mobile device.

FIG. 5 shows the components of the system of FIG. 4 that are associated with registration of apps by developers and with submission of advertisements by advertisers.

FIG. 6 shows the process by which the Adserver computes a mobile device's position and velocity according to one embodiment of the disclosure.

FIG. 7 shows the components of the system of FIG. 4 that are associated with selection of advertisements that are proximate to a user's present position or predicted future position.

FIG. 8 shows the components of the present disclosure which accompany an advertisement presented on a mobile device in one embodiment of the disclosure.

FIG. 9 shows the components of the system of FIG. 4 that enable a user to make a reservation or place an advance order associated with a presented advertisement, record the user's advertisement preferences, and save the presented advertisement for later use.

FIG. 10 is a process flow diagram that shows the steps in a method for presenting advertisements to a mobile device user according to one embodiment of the present disclosure.

### DETAILED DESCRIPTION

The present disclosure presents in-application direction based advertisements to a user of a mobile device, which may be a smartphone, a tablet computer, an automobile's navigation system, an in-vehicle television receiver, a vehicle infotainment system, or another type of mobile device. It presents advertisements through one or more apps that the user has opened on the device (“in-app advertising”).

Advertisements presented to a user by the present disclosure may promote a business which offers any type of goods or services, including without limitation a store, a shop, a movie theater, a car dealership, a restaurant, a museum, an airline, a cruise line company, a zoo, a beach, an athletic club, and a sports arena.

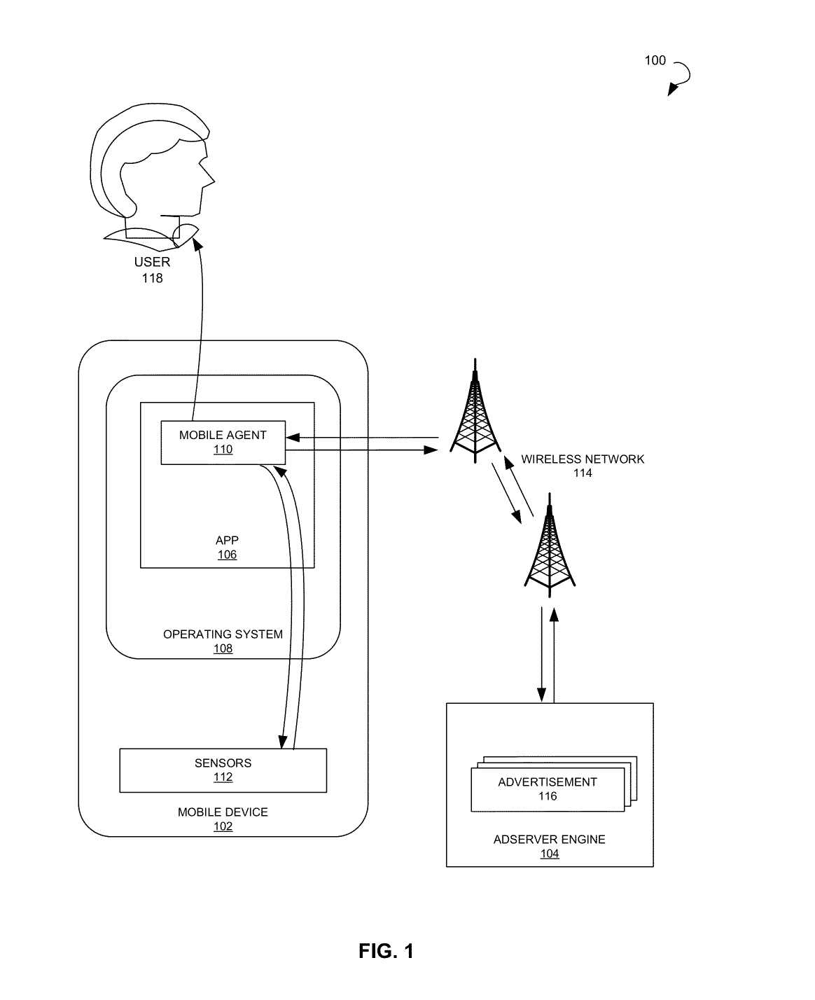

FIG. 1 shows the relationship in the present disclosure 100 between the mobile device 102 and the Adserver 104. The mobile device 102 runs an app 106 under an operating system 108. The app 106 comprises a Mobile Agent 110. The Mobile Agent 110 obtains sensor readings from one or more sensors 112 and communicates them to the Adserver 104 through a wireless network 114. The Adserver 104 transmits one or more advertisements 116 to the Mobile Agent 110, which the Mobile Agent 110 presents to the user 118.

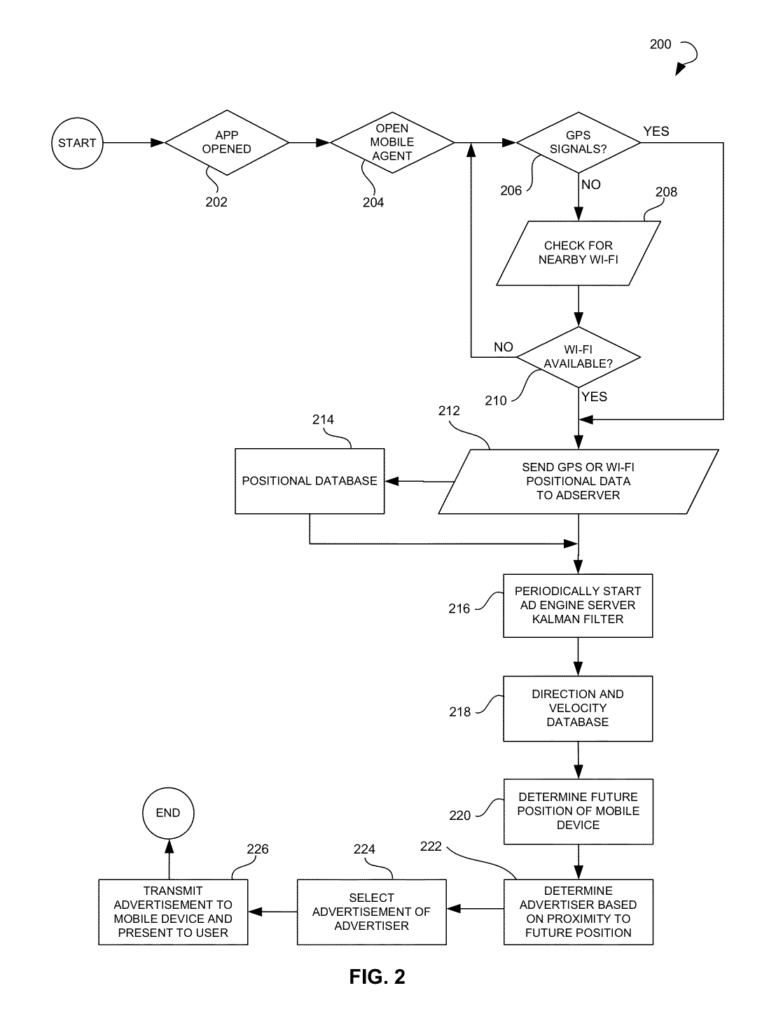

FIG. 2 shows one embodiment of the present disclosure which is a process that determines the position of a mobile device, selects one or more advertisements to present to a user of the device, and transmits the advertisements to the device, where they are presented to the user.

The process 200 begins when the user opens an app 202 that is integrated with a Mobile Agent 204. The app 202 opens the Mobile Agent 204. The Mobile Agent 204 checks whether the mobile device has a GPS receiver and is receiving a usable set of GPS signals 206.

If a usable set of GPS signals 206 is not available, the Mobile Agent 204 checks whether Wi-Fi signals 208 are available 210. If Wi-Fi signals 208 are not available 210, the Mobile Agent 204 periodically repeats the checks for GPS signals 206 and Wi-Fi signals 208. When a usable set of GPS signals 206 or Wi-Fi signals 208 are available 210, the Mobile Agent sends positional data from the available sensors (“positional data”) 212 to an Adserver, which stores the positional data 212 in a Positional Database 214. For power conservation the GPS receiver and Wi-Fi transceiver may be sampled to establish an initial location, and then the system may turn off the GPS receiver and Wi-Fi transceiver and only sample accelerometer and compass readings infrequently.

The Adserver periodically starts a Kalman filter 216 which increases the accuracy of the positional data 212 stored in the Positional Database 214 which is received from the accelerometer, compass, gyroscope, or proximity sensor.

A Predictive Module periodically analyzes the positional data 212 stored in the Positional Database 214 and determines the mobile device's present velocity (speed and direction of motion), and stores the velocity in a Velocity Database 218. From the mobile device's present velocity the Predictive Module, using Bayesian analysis, may deduce additional information, such as the mobile device user's mode of travel, and may store the additional information in the Velocity Database 218. The Predictive Module further uses the mobile device's present velocity and deduced additional information to predict a future position 220 (a destination) of the mobile device and thus of the mobile device's user.

A Decision Module periodically uses the information in the Adserver's databases, including the Positional Database 214 and the Velocity Database 218, to determine one or more advertisers 222 whose advertisements are likely to elicit a positive response from the user, and then to select one or more advertisements 224 associated with those advertisers that are most likely to elicit a positive response. A Communication Module transmits the selected advertisements 224 to the Mobile Agent 204, which presents them to the user.

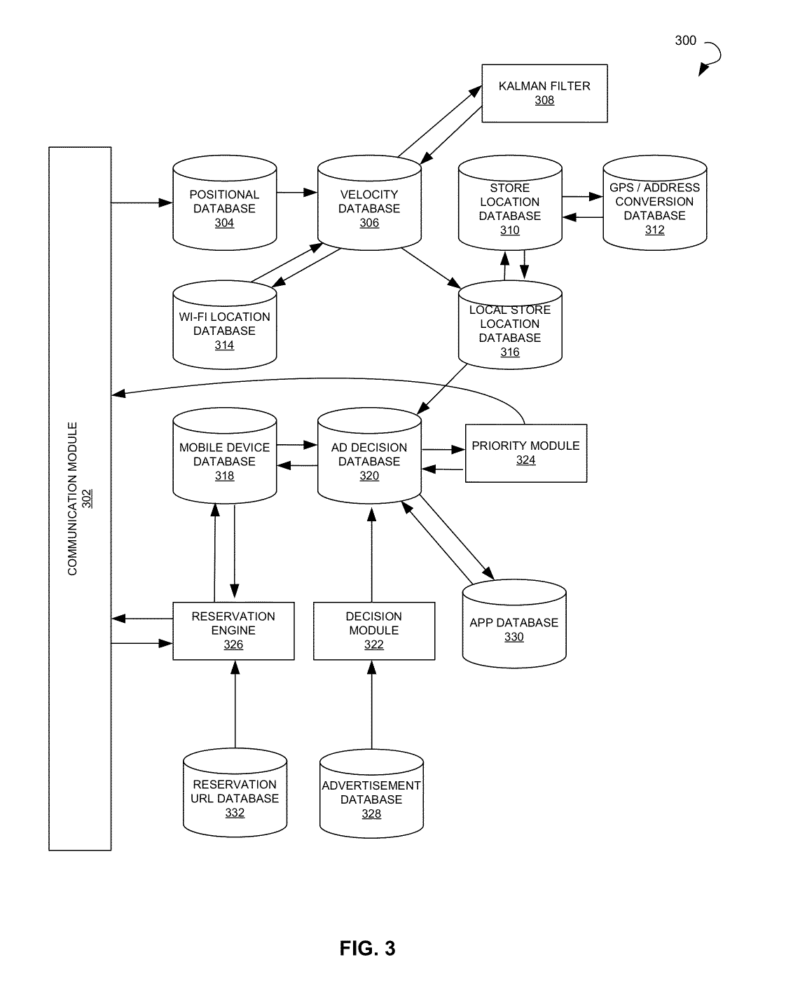

FIG. 3 shows the important databases in the Adserver 300 in the embodiment of the disclosure shown in FIG. 2 and the flow of data among them and between them and their associated modules.

A Communication Module 302 transmits information comprising advertisements and instructions from the Adserver 300 to a Mobile Agent and receives information comprising positional data and user input from the Mobile Agent. Information flows through the Communication Module 302 to and from the Adserver 300's databases.

A Positional Database 304 stores positional data received from the Mobile Agent.

A Velocity Database 306 stores velocity data which the Predictive Module computes from the positional data and additional data which the Predictive Module deduces from the velocity data. The Predictive Module periodically runs a Kalman filter 308 on the velocity data to improve its accuracy.

A Store Location Database 310 stores the locations of places of business (“stores”) associated with advertisers who use the present disclosure to distribute advertisements. A store may be a place of business of any type of advertiser, including without limitation a shop, a restaurant, or a service establishment such as a dry cleaner or a barber shop.

A GPS/Address Conversion Database 312 stores information which the Adserver 300 may use to convert GPS positions to street addresses and vice versa. The Adserver 300 may use this capability to determine the distance from a current or predicted future position of a mobile device's user to a store location kept in the Store Location Database 310.

A Wi-Fi Location Database 314 stores the locations of Wi-Fi hotspots from which the Adserver 300 may determine the position of the mobile device.

A Local Store Location Database 316 stores the locations of stores in the Store Location Database 310 that are within a specified distance of the present position or a predicted future position of the mobile device's user.

A Mobile Device Database 318 stores identifying properties of the user and App of each mobile device, enabling the Adserver 300 to track the activities of individual users over time.

An Ad Decision Database 320 stores data used by a Decision Module 322 to determine which advertisements stored in an Advertisement Database 328 may be presented to the mobile device's user depending on the type of app that is open on the mobile device and the properties of apps stored in an App Database 330.

A Priority Module 324 determines the order of presentation for advertisements which the Decision Module 322 has selected for presentation to the mobile device's user.

In some embodiments a Reservation Engine 326 makes a reservation on behalf of the mobile device's user at a store associated with an advertisement presented to the user. The Reservation Engine 326 may make an advance order in addition to a reservation or instead of a reservation. If the Reservation Engine 326 makes an advance order it may further execute a financial transaction which causes the user to pay for the advance order.

In other embodiments the Reservation Engine 326 connects the mobile device's user directly to a reservation system associated with the advertisement, enabling the user to make a reservation directly. The reservation system associated with the advertisement may also provide means for the user to make an advance order in addition to a reservation or instead of a reservation, and to pay for the advance order.

A Reservation URL Database 332 contains URLs of reservation systems associated with advertisements that may be presented to users.

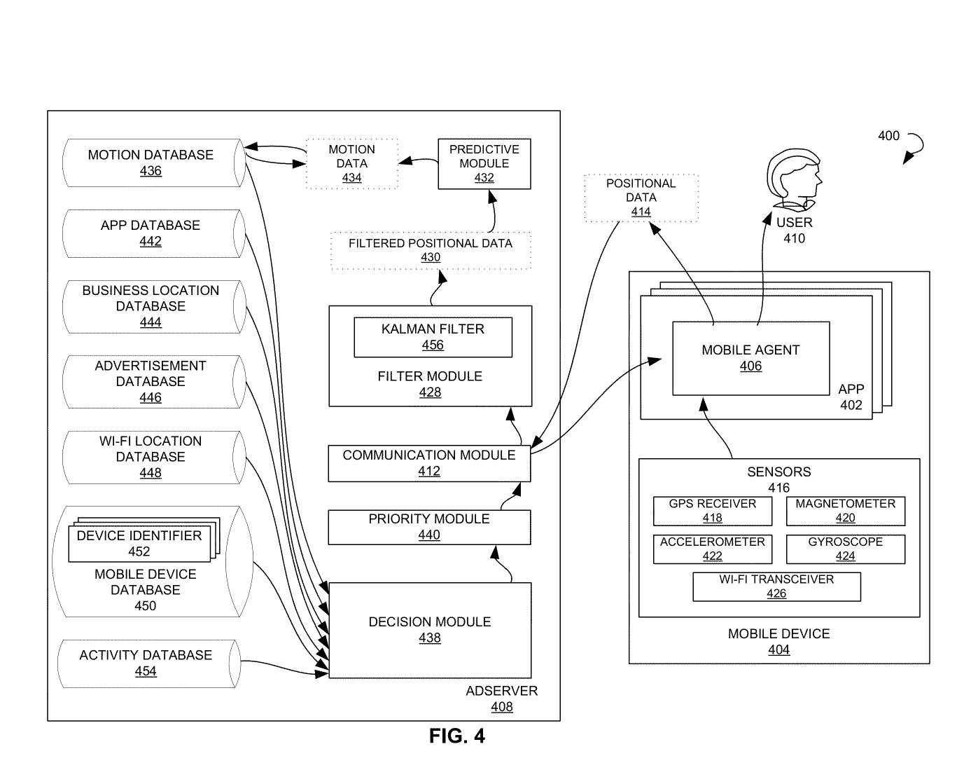

FIG. 4 shows one embodiment of the present disclosure which is a system 400 whose major components are one or more apps 402 which run on a mobile device 404; at least one sensor 416 associated with the mobile device 404 and operable to detect data which may be used to determine the position of the mobile device (positional data 414); a Mobile Agent 406 embedded in each app 402 by means of a software development kit or software library (“SDK”); and an advertisement server 408 (“the Adserver”) which stores advertisements, analyzes data received from the Mobile Agent 406, selects advertisements for presentation to the user 410, and sends the advertisements to the Mobile Agent 406 for display.

The Adserver 408 comprises a Communication Module 412 which receives data from and transmits data to the Mobile Agent 406; a Filter Module 428 which filters the positional data 414, producing filtered positional data 430; a Predictive Module 432 which determines motion data 434 based on the filtered positional data 430 and may determine a future position the user 410; a Motion Database 436 which stores the motion data 434; a Decision Module 438 which selects advertisements for presentation to the user 410; a Priority Module 440 which determines the order in which the selected advertisements will be transmitted to the mobile device 404; an App Database 442 which contains information about each app 402 into which the Mobile Agent 406 has been integrated; a Business Location Database 444 which contains the business locations of advertisers; an Advertisement Database 446 which contains advertisements submitted for presentation to users by the advertisers and advertising parameters which describe the properties of the advertisements; a Wi-Fi Location Database 448 which contains locations of Wi-Fi hotspots; and a Mobile Device Database 450 which stores a device identifier 452 for each mobile device 404 that communicates with the Adserver 408, the device identifier 452 including one or more of the mobile device 404's MAC address, IP Address, UDID, Advertising Identifier, and type and release of operating system; and an Activity Database 454 which contains activity data, the activity data describing each user's history of running apps 402 that are integrated with the Mobile Agent 406 and of responding to advertisements by clicking buttons associated with the advertisements.

The Adserver 408 may use the Mobile Device Database 450 to store mobile device identifying data which may be used to distinguish a particular mobile device 404 from other mobile devices 404, and data about the activities of the mobile device 404's user 410. Because the data in the Mobile Device Database 450 identifies the mobile device 404, and not the user 410, the Mobile Device Database 450 contains no information that would compromise the user 410's privacy by making it possible to personally identify the user 410.

The Mobile Agent 406 collects positional data 414 from the at least one sensor 416 and transmits it to the Adserver 408's Communication Module 412.

The Filter Module 428 comprises a Kalman filter 456 operable to process the positional data 414 to correct sensor noise, thereby producing filtered positional data 430.

Another embodiment of the present disclosure is a group of processes that integrate the Mobile Agent 406 into one or more apps 402; build the Adserver's databases 436, 442, 444, 446, 448, 450, 454; and present advertisements to individual users based on factors which include, without limitation, each advertisement's market segment, each advertiser's store locations, each user 410's position, direction, and mode of travel, each user 410's current activity as represented by the type of app the user is running, and each user's history of responses to advertisements displayed in the past.

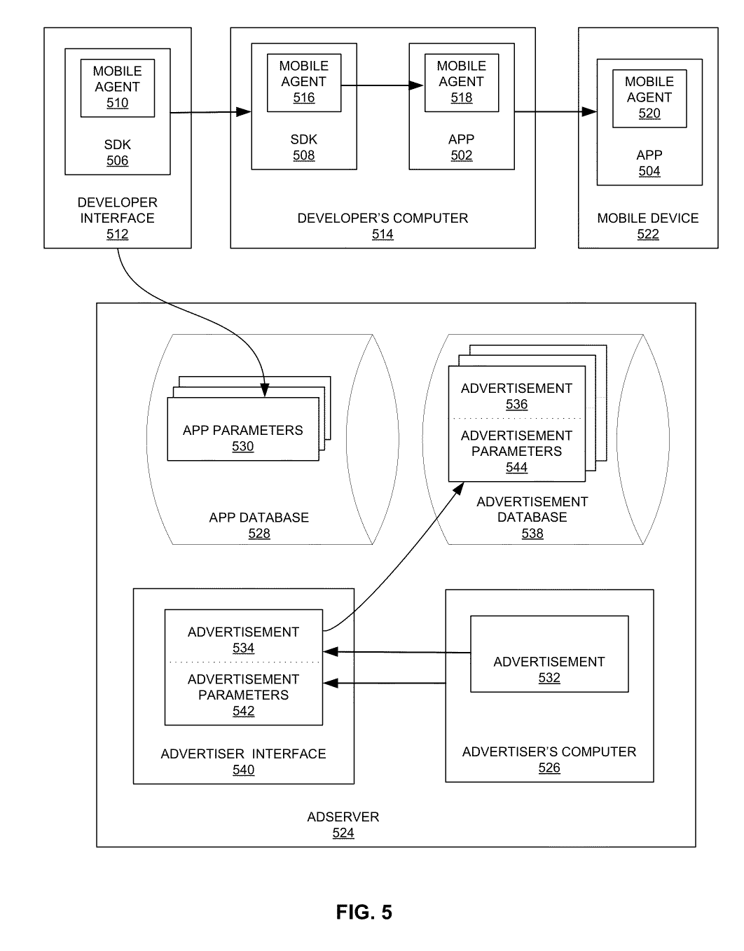

Turning now to FIG. 5, a developer enables an app 502, 504 to interoperate with the present disclosure by downloading a Software Development Kit or software library (SDK) 506, 508 from a Developer Interface 512 to a developer's computer 514 and following instructions that accompany the SDK 506, 508. By this means the developer incorporates a Mobile Agent 510, 516, 518, 520 into the app 502, 504. The Mobile Agent 510, 516, 518, 520 performs those parts of the disclosure's advertisement selection and presentation functions which must be performed on the mobile device 522 and communicates with the Adserver 524, which performs the remaining parts of those functions.

The Developer Interface 512 further enables the developer to register the app 502, 504 in the Adserver 524's App Database 528 and to provide one or more app parameters 530 which characterize the app 502, 504. The app parameters 530 may include, without limitation, the type of the app 502, 504 and one or more vertical markets of which the app 502, 504's users will typically be members. Examples of types of apps include, without limitation, games, navigation apps, and financial apps. Examples of vertical markets include, without limitation, sports fans, games, gardening enthusiasts, and tradesmen.

An advertiser adds one or more advertisements 532, 534, 536 to an Advertisement Database 538 by submitting it to the Adserver 524 through an Advertiser Interface 540 from an advertiser's computer 526.

The Advertiser Interface 540 also enables the advertiser to set advertisement parameters 542, 544 for the advertisement 532, 534, 536, the advertisement parameters 542, 544 being added to the Advertisement Database 538 with the associated advertisement 532, 534, 536. The advertisement parameters may include, without limitation, categories of users. Categories of users may comprise, without limitation, sports, gaming, finance, home and garden, and fashion. The Adserver 524 may use the advertisements 536's advertisement parameters 544 in selecting advertisements 536 to be presented to the user.

Returning to FIG. 4, the Decision Module 438 retrieves app parameters for the app 402 from the App Database 442, retrieves advertisement parameters for available advertisements from the Advertisement Database 446, and uses the advertisement parameters to select advertisements for presentation to the user 410 that the user 410 is likely to consider useful.

When a user is running an app 402 that is integrated with the disclosure, the Mobile Agent 406 periodically reads positional data 414 from at least one sensor 416 associated with the mobile device 404. The positional data 414 describes the mobile device 404's position and movement. The at least one sensor 416 may comprise, without limitation, a GPS receiver 418, a magnetometer 420, an accelerometer 422, a gyroscope 424, and a Wi-Fi transceiver 426.

The Mobile Agent 406 transmits the positional data 414 to the Filter Module 428 in the Adserver 408 through the Communication Module 412. The Filter Module 428 applies mathematical techniques to the positional data 414, yielding filtered positional data 430. By this means the Filter Module 428 removes anomalous readings from the positional data 414 and corrects for movement of the mobile device 404 in the user 410's pocket, transient deviations from the user 410's route, and other non-significant changes in the positional data 414.

The Predictive Module 432 uses the filtered positional data 430 to compute motion data 434 and stores the motion data 434 in the Motion Database 436. The motion data 434 may comprise, without limitation, the mobile device 404's latitude, longitude, elevation, and velocity. The Predictive Module 432 may further use a predictive algorithm to predict one or more of a future position of the mobile device 404, the future route of the user 410, and the destination of the user 410, based on the filtered positional data 430 and the motion data 434. The Predictive Module 432 may add the predicted future position, future route, and destination to the motion data 434 stored in the Motion Database 436.

The Adserver 408 may direct the Mobile Agent 406 to collect positional data 414 from one or more different sensors 416 depending on the types of sensors 416 available on the mobile device 404 and their operational status. For example, the Adserver 408 may preferentially use a GPS receiver to determine the mobile device 404's positional data 414. If the mobile device 404 does not have a functioning GPS receiver, the Adserver 408 may use the Wi-Fi transceiver to collect positional data 414, enabling the Predictive Module 432 to deduce the mobile device 404's position from the identities and signal strengths of available Wi-Fi hotspots. If no Wi-Fi hotspots are available, the Adserver 408 may use an accelerometer to collect positional data 414, enabling the Predictive Module 432 to extrapolate the mobile device 404's present position from its last known position. The Adserver 408 chooses sensors 416 to produce the most accurate and useful positional data 414 while minimizing demands on the mobile device 404's power source.

After the Filter Module 428 has determined the mobile device 404's position from positional data 414 obtained from a GPS receiver 418, and the Predictive Module 432 has determined the mobile device 404's velocity from the positional data 414, the Adserver 408 may update the motion data 434 without further reference of the GPS receiver 418 by monitoring positional data 414 from the accelerometer 422 which the Mobile Agent 406 transmits to the Adserver 408 when the Mobile Agent 406 detects a change in the mobile device 404's velocity. By this means the disclosure reduces the Mobile Agent 406's demands on the mobile device 404's power source.

In cases where no positional data 414 is available or the available positional data 414 is insufficient for computing useful motion data 434, the Predictive Module 432 may use the mobile device 404's last known position as a starting point for dead reckoning of the positional data.

The Filter Module 428 processes the positional data 414 with a Kalman filter 456.

In some embodiments of the disclosure the Kalman filter 456 processes positional data 414 from mobile device 404's magnetometer 420 and accelerometer 422 to determine changes in velocity with a minimum demand on the mobile device 404's power and other resources.

In some embodiments of the disclosure the Filter Module 428 comprises a Quaternion filter which employs Quaternion mathematics to estimate the direction and acceleration of the mobile device 404 and thereby improve the accuracy of the filtered positional data 430.

The Predictive Module 432 may derive additional information about the mobile device 404's movement by reprocessing the motion data 434. For example, from the mobile device 404's velocity and pattern of movement the Predictive Module 432 may determine whether the user 410 of the mobile device 404 is engaged in driving a motor vehicle, riding a bicycle, jogging, walking, or remaining motionless. Such additional information about the mobile device 404's movement may be incorporated into the motion data 434.

The Predictive Module 432 may use the motion data 434 to determine the significance of subsequent motion data 434. For example, the Predictive Module 432 may use recent sets of motion data 434 to determine whether a next set of motion data 434 is consistent with the user's previous motion, indicates a change in motion such as getting out of a motor vehicle, or represents an anomalous reading.

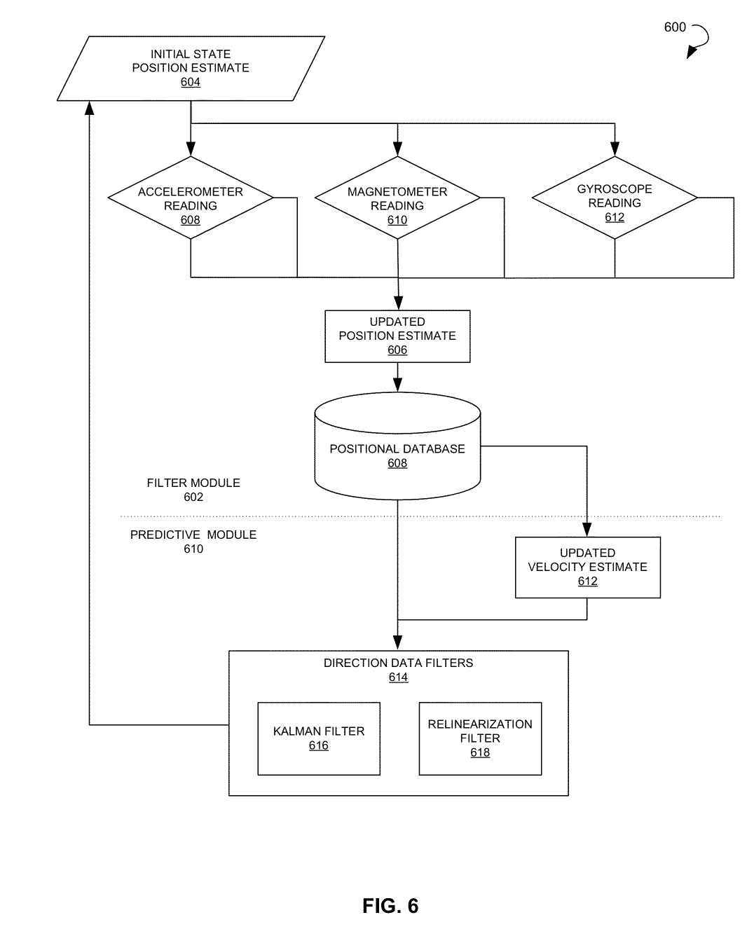

FIG. 6 shows the process by which the Adserver 600 computes a mobile device's position and velocity according to one embodiment of the disclosure. The Filter Module 602 combines an initial state position estimate 604 of the mobile device's position with a sensor reading to produce an updated position estimate 606. The sensor reading may be an accelerometer reading 608, a magnetometer reading 610, or a gyroscope reading 612, depending on the availability of each type of sensor reading. The updated position estimate 606 is stored in the Positional Database 608. The Predictive Module 610 retrieves the updated position estimate 606 from the Positional Database 608 and uses the updated position estimate 606 to compute an updated velocity estimate 612. The Predictive Module 610 passes the updated velocity estimate 612 through one or more direction data filters 614, comprising one or more of a Kalman filter 616 using Quaternion mathematics and a relinearization filter 618. The Adserver 600 then repeats the process, using the product of the direction data filters 614 as a new initial state position estimate 604.

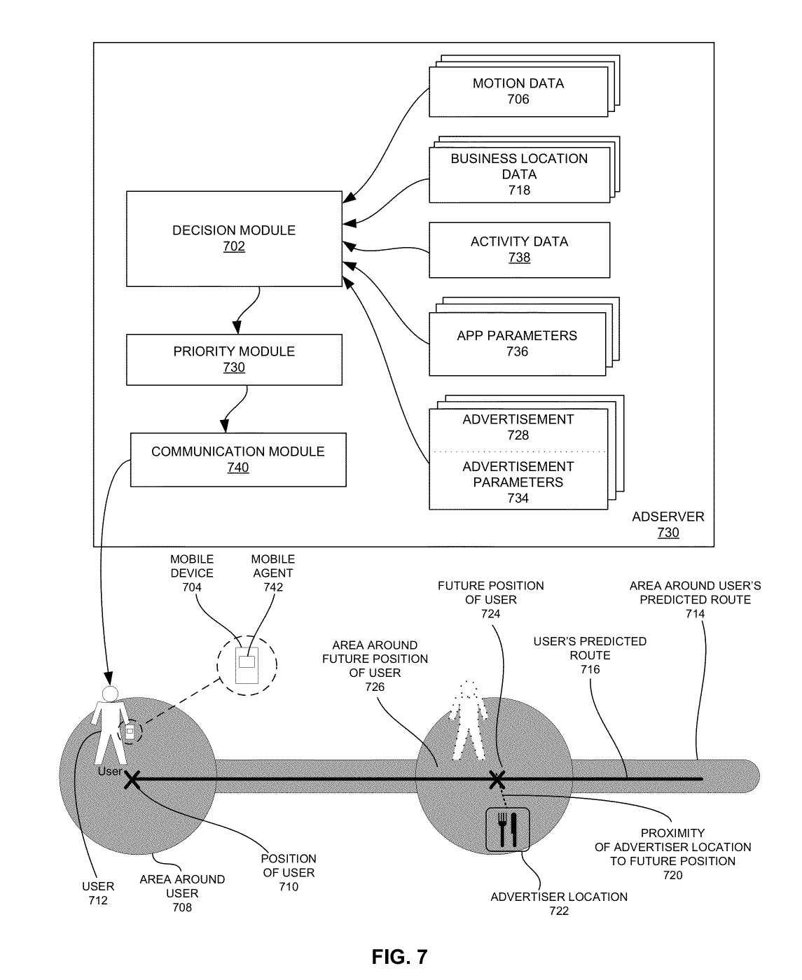

Turning now to FIG. 7, the Decision Module 702 may use the mobile device 704's motion data 706 to determine an area 708 around the position of the user 710, an area 726 around the predicted future position of the user 724, or an area 714 around the user's predicted route 716.

The Decision Module 702 may also use the mobile device 704's motion data 706 and business location data 718 to determine a proximity 720 of one or more locations 722 of an advertiser to a future position of the user 724 of the mobile device 704, to select one or more advertisers which have at least one business location within the area 708 around the user's position 710, the area 726 around the future position of the user 724, or the area 714 around the user's predicted route 716, and to select one or more advertisements 728 associated with a selected advertiser. The proximity 720 may be measured, without limitation, in terms of distance or travel time.

The Decision Module 702 may select advertisements 728 for presentation to the user 712 according to criteria which apply to at least one of the advertisement parameters 734, the app parameters 736, the motion data 706, the user 712's activity data 738, and the business location data 718 of each advertiser.

In some embodiments of the disclosure the Decision Module 702 may first select one or more advertisers based on the proximity 720 of each advertiser's location 722 to the future position of the user 724, then select one or more advertisements 728 associated with the selected one or more advertisers to present to the user 712.

The Priority Module 730 may determine the order in which advertisements 728 are presented to the user 712 according to any type of data stored in the Adserver 730's database, including without limitation the app parameters 736, the user 712's activity data 738, the advertisement parameters 734 associated with the advertisements 728, the motion data 706, and the business location data 718 of each advertiser associated with one or more of the advertisements 728.

The Communication Module 740 transmits the selected one or more advertisements 728 to the Mobile Agent 742, which presents the one or more advertisements 728 to the user 712.

The selected one or more advertisements 728 may be presented to the user 712 through any medium which the mobile device 704 is capable of rendering, including without limitation text, graphics, audio, and video.

The Mobile Agent 742 may present advertisements 728 to the user 712 outside the app on mobile devices that allow out-of-app presentation.

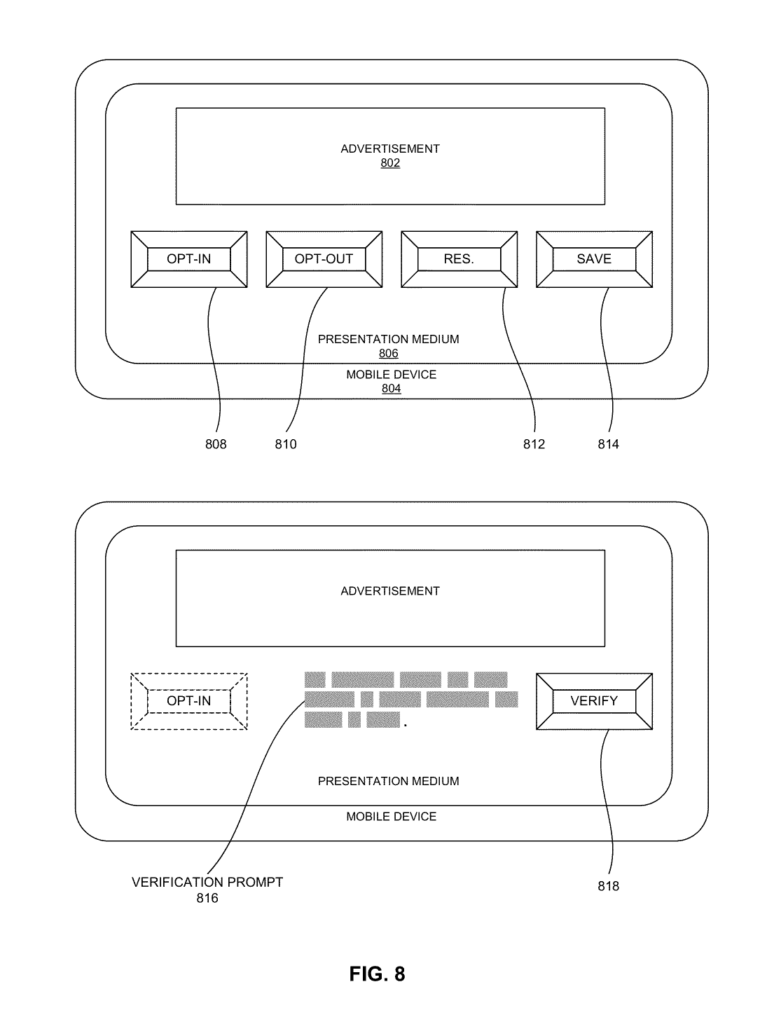

FIG. 8 shows the components of the present disclosure which accompany an advertisement 802 presented on a presentation medium 806 of a mobile device 804 in one embodiment of the disclosure. The presentation medium 806 may be any medium which the mobile device 804 affords for presenting the advertisement 802 to a user, such as a liquid crystal display (LCD). Elements of the present disclosure which appear in the presentation comprise an Opt-In Button 808 which the user may click to express a desire to see similar ads in the future, an Opt-Out Button 810 which the user may click to express a desire not to see similar ads in the future, a Reservation Button (“RES.”) 812 which the user may click to do one or more of placing a reservation, placing an advance order, and paying for an advance order, and a Save button 814 which the user may click to store the advertisement 802 to a folder associated with the mobile device 804.

If the user clicks the Opt-In Button 808 the disclosure may display a verification prompt 816 and a Verification Button 818. To confirm the choice to opt in the user must click the Verification Button 818 according to instructions in the verification prompt 816. By requiring the user to perform two clicks to express and confirm the desire to opt in, the disclosure avoids performing the opt-in action in cases where the user clicks the Opt-In Button 808 by accident or the user has a pocket click or accidental click on the advertisement.

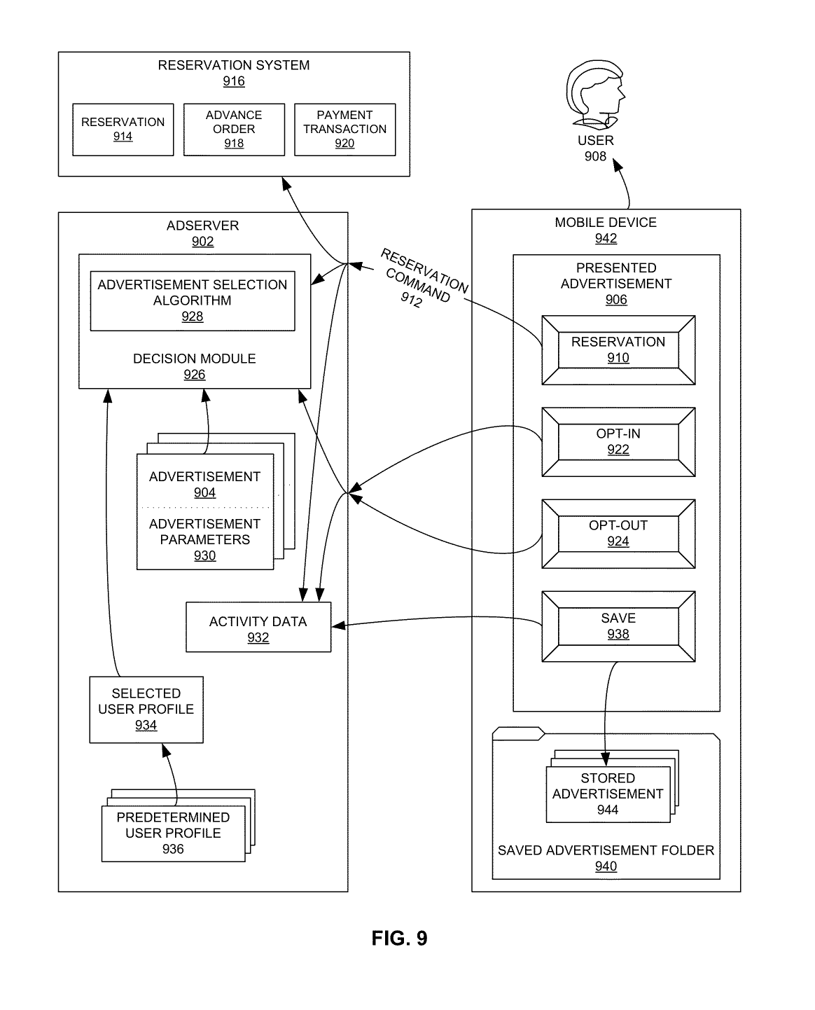

Turning now to FIG. 9, when the user 908 clicks the Reservation Button 910, the Mobile Device 942 transmits a reservation command 912 to the Adserver 902. When the Adserver 902 receives the reservation command 912 it causes a reservation 914 associated with the advertisement 904 to be made for the user 908 on a reservation system 916 associated with the presented advertisement 906.

In one embodiment of the disclosure the Adserver 902 makes the reservation 914 on the user 908's behalf. The Adserver 902 may place an advance order 918 in addition to making the reservation 914 or instead of making the reservation 914. If the Adserver 902 places an advance order 918 it may also execute a payment transaction 920 which causes the user to pay for the advance order 918.

In another embodiment of the disclosure the Adserver 902 connects the user 908 directly to the reservation system 916 associated with the presented advertisement 906, enabling the user 908 to make the reservation 914 directly. The reservation system 916 may further provide means for the user 908 to place an advance order 918 in addition to making the reservation 914 or instead of making the reservation 914, and to execute a payment transaction 920 by which the user 908 pays for the advance order 918.

The Adserver 902 may cause the presented advertisement 906 to be accompanied by one or more of an Opt-In Button 922, an Opt-Out Button 924, and a Save Button 938. The Adserver 902 may collect activity data 932 which comprises the user 908's selections of the Reservation Button 910, the Opt-In Button 922, the Opt-Out Button 924, and the Save Button 938. The Decision Module 926 may utilize the user 908's activity data 932 to weight an advertisement selection algorithm 928 toward or against presenting advertisements 904 with advertisement parameters 930 similar to the advertisement parameters 930 associated with the presented advertisement 906, or to completely exclude such advertisements from presentation.

The Adserver may refine the advertisement selection algorithm 928 by applying Bayesian analysis to the activity data 932 associated with groups of users 908 or with all users 908.

The Adserver 902 may select a user profile 934 from a plurality of predetermined user profiles 936 and associate the selected user profile 934 with the user 908 by applying Bayesian analysis to the activity data 932 associated with an individual user 908. The Decision Module 926 may base its selection of advertisements 904 to be presented to the user 908 partly or entirely on the user 908's selected user profile 934. The selected user profile 934 may characterize the user 908 according to the user 908's interests as represented by the user 908's activity data 932, including, by way of example and without limitation, a sports fan, a runner, a cyclist, and a skier, a school teacher, and a tradesmen.

The Adserver 902 may provide a Save Button 938 operable to store the presented advertisement 906 in a folder 940 associated with the mobile device 942, creating a stored advertisement 944. The user 908 may redisplay the stored advertisement 944 at a future time.

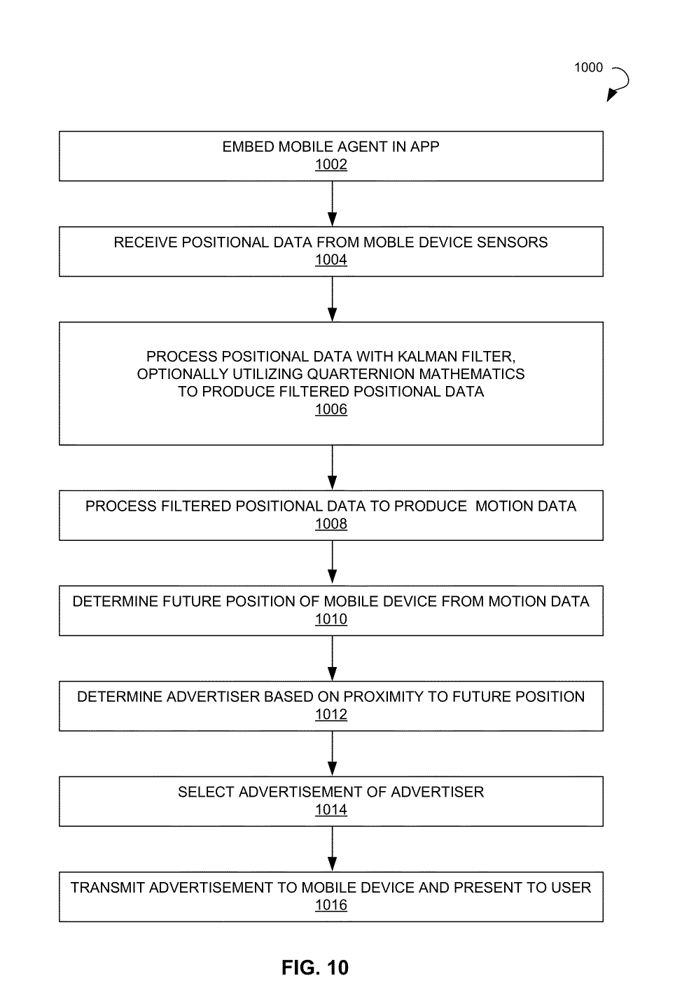

FIG. 10 is a process flow diagram showing a method 1000 for presenting advertisements to a mobile device user according to one embodiment of the present disclosure. The method 1000 may be performed by a combination of software running on a general purpose computer, software running on a mobile device, and hardware components in the mobile device.

The first step 1002 of the method 1000 embeds a Mobile Agent in an app associated with a mobile device.

The second step 1004 receives positional data from one or more sensors associated with the mobile device.

The third step 1006 processes the positional data with a Kalman filter to correct sensor noise, thereby producing filtered positional data using Quarternion mathematics to improve the accuracy of the filtered positional data.

The fourth step 1008 processes the filtered positional data to produce motion data.

The fifth step 1010 determines a future position of the mobile device from the motion data.

The sixth step 1012 determines an advertiser based on a proximity of one or more of the advertiser's places of business to the future position of the mobile device.

The seventh step 1014 selects an advertisement of the advertiser.

The eighth step 1016 transmits the selected advertisement to the mobile device and presents it to the user.

In this specification, reference to “one embodiment,” “an embodiment,” “various embodiments,” or “some embodiments” means that a particular feature, structure, or characteristic described in connection with the embodiment can be included in at least one embodiment of the disclosure. The appearances of these phrases in various places in the specification do not necessarily all refer to the same embodiment, nor are separate or alternative embodiments mutually exclusive. Further, the order of blocks in process flowcharts or diagrams, if any, representing one or more embodiments of the disclosure do not inherently indicate any particular order nor imply any limitations in the disclosure.

The techniques of the embodiments disclosed herein may be implemented using a variety of technologies. For example, the methods described herein may be implemented in software executing on a computer system or a mobile device, or in hardware utilizing either a combination of microprocessors or other specially designed application-specific integrated circuits (ASICs), programmable logic devices, or various combinations thereof.

Other embodiments of the disclosure will be apparent to those skilled in the art from a consideration of this specification or practice of the disclosure disclosed herein. It is intended that the specification and examples be considered as exemplary only, with the true scope and spirit of the disclosure being indicated by the following claims.

What is claimed is:

1. A method for presenting in-application direction based advertisements, the method comprising:
providing a Mobile Agent to be embedded in at least one application associated with a mobile device and a Software Development Kit (SDK) operable to embed the SDK in the at least one application associated with the mobile device;
receiving positional data from at least one sensor associated with the mobile device;
processing the positional data using Kalman filter technology to correct sensor noise, thereby producing filtered positional data;
processing the filtered positional data to produce motion data;
determining a future position of the mobile device based on the motion data;
selectively determining at least one advertiser based on a proximity of a place of business of the at least one advertiser to the future position;
selecting at least one advertisement associated with the at least one advertiser; and
transmitting the at least one advertisement to the mobile device, the at least one advertisement being presented to a user associated with the mobile device via the at least one application.

2. The method of claim 1, further comprising:
receiving, from the user associated with the mobile device, a command to make a reservation associated with the at least one advertisement; and
connecting the user directly to a reservation system associated with the at least one advertisement.

3. The method of claim 1, further comprising:
receiving, from the user associated with the mobile device, a command to make one or more of a reservation, an advance order, and payment for the advance order, the reservation, advance order, and payment for the advance order being associated with the at least one advertisement;
communicating with a reservation system independent of the present disclosure; and
making the one or more of the reservation, the advance order, and the payment for the advance order on the user's behalf.

4. The method of claim 1, further comprising:
collecting activity data associated with the user of the mobile device;
applying Bayesian analysis to the activity data; and
based on the Bayesian analysis of the activity data, selecting one of a plurality of predetermined user profiles, the selection of the at least one advertisement associated with the at least one advertiser being based on the selected predetermined user profile.

5. The method of claim 4, wherein the predetermined user profile includes one or more of the following: a sports fan, a runner, a cyclist, and a skier, a school teacher, and a tradesmen.

6. The method of claim 1, wherein the determining of the future position includes applying Quaternion mathematics to the motion data to determine a direction and an acceleration of the mobile device.

7. The method of claim 1, further comprising allowing the user to store the at least one advertisement to a folder associated with the mobile device.

8. The method of claim 1, wherein the positional data includes one or more of the following parameters associated with the mobile device: a position, an altitude, a velocity, and an acceleration.

9. The method of claim 8, wherein the positional data is determined using one or more of the following location services: Wi-Fi, GPS, and triangulation.

10. The method of claim 1, wherein the at least one sensor includes one or more of the following sensors: a GPS receiver, Wi-Fi transceiver, a magnetometer, a gyroscope, and an accelerometer.

11. The method of claim 10, wherein the motion data is updated without reference to the GPS receiver by use of data from the accelerometer, the data from the accelerometer being used to update the motion data when a change in the mobile device's velocity is detected.

12. The method of claim 1, further comprising determining based on the motion data whether a user associated with the mobile device is engaged in one or more of the following activities: driving a motor vehicle, riding a bicycle, jogging, walking, and remaining motionless.

13. The method of claim 1, wherein the future position of the user is associated with one or more of the following: an area around the user's position and an area along the user's predicted route.

14. The method of claim 1, wherein the at least one advertisement is selected according to at least one category specified by the at least one advertiser, the categories including one or more of the following: sports, gaming, finance, home and garden, and fashion.

15. The method of claim 14, further comprising providing the advertiser with an Advertiser Interface, the Advertiser Interface to allow the advertiser to provide one or more advertisement parameters.

16. The method of claim 1, further comprising providing a developer with a Developer Interface, the Developer Interface to allow the developer to download the SDK, embed the Mobile Agent into the at least one application, and provide one or more application parameters.

17. The method of claim 1, further comprising identifying the mobile device based on a device identifier, the device identifier including or more of the following: a MAC address, an IP Address, an UDID, an Advertising Identifier, and a type and release of operating system.

18. The method of claim 1, wherein the at least one advertiser includes one or more of the following: a store, a shop, a movie theater, a car dealership, a restaurant, a museum, an airline, a cruise line company, a zoo, a beach, an athletic club, and a sports arena.

19. The method of claim 1, wherein the at least one advertisement is presented to the user via one or more of an in-vehicle television receiver and a vehicle infotainment system.

20. The method of claim 1, wherein the at least one sensor are read by an in-app Mobile Agent running within the at least one application on the mobile device.

21. The method of claim 1, further comprising using the last known Wi-Fi or GPS position as a starting point for dead reckoning of the positional data.

22. A system for presenting in-application direction based advertisements, the system comprising:
a Mobile Agent to be embedded in at least one application associated with a mobile device;
a Software Development Kit (SDK) operable to embed the Mobile Agent in the at least one application associated with the mobile device;
a Communication Module operable to receive positional data from at least one sensor associated with the mobile device;
a Kalman filter operable to process the positional data and to correct sensor noise, thereby producing filtered positional data;
a Predictive Module operable to determine a future position of the mobile device based on the filtered positional data;
a Business Location Database operable to provide a selection of at least one advertiser based on a proximity of the at least one advertiser to the future position; and
an Advertisement Database operable to provide a selection of at least one advertisement associated with the at least one advertiser, wherein the Communication Module is operable to transmit the at least one advertisement to the mobile device, the at least one advertisement being presented to a user associated with the mobile device via the at least one application.
